(19) United States
(12) Patent Application Publication
(10) Pub. No.: US 2008/0103993 A1
(43) Pub. Date: May 1, 2008

(54) Method for providing energy to a building using utility-compatible distributed generation equipment

(75) Inventors: Joel R. Wilson, Weston, CT (US); Joshua R. Wilson, Weston, CT (US); Richard J. Slember, White Stone, VA (US); Richard M. Kesselman, Westport, CT (US); Andrew J. Edwards, Redding, CT (US); John S. Pifer, Easton, CT (US); Robert W. Jannino, Stamford, CT (US); Joseph N. Allen, Fairfield, CT (US); Stephen R. MacDonald, New York, NY (US); Thomas D. Cunningham, Rowayton, CT (US)

Correspondence Address: FIALA & WEAVER, P.L.L.C.;C/O INTELLEVATE, P.O. BOX 52050, MINNEAPOLIS, MN, 55402, US

(73) Assignee: OfficePower, L.L.C., Norwalk, CT (US)

(21) Appl. No.: 11/586,646

(22) Filed: Oct. 26, 2006

(51) Int. Cl. G06F 17/00

(52) U.S. Cl. 705/412

(57) ABSTRACT

A method for providing energy to a building using utility-compatible distributed generation equipment. In accordance with the method, a building owner leases space in a building to an energy provider. The energy provider installs or has installed utility-compatible distributed generation equipment in the leased space at no capital cost to the building owner, wherein the distributed generation equipment is capable of providing electric energy or both electric and thermal energy to the building. The energy provider also installs or has installed a gas delivery system that is capable of delivering natural gas from a gas utility interface to the distributed generation equipment in a manner that meets the gas pressure and volume requirements of the distributed generation equipment. The building owner uses the energy provided by the distributed generation equipment on a first use basis. The building owner pays the energy provider approximately the same amount for the energy provided by the distributed generation equipment that the building owner would have paid to a local utility or to a third party supplier and a local utility for the supply and delivery of the same amount of energy.

### BACKGROUND OF THE INVENTION

1. Field of the Invention

The present invention is generally related to the provision of energy to a building. In particular, the present invention is related to a method for providing electric power, and optionally heating and cooling, to a building using on-site distributed generation equipment that can operate in parallel with and independently from more traditional energy sources, such as grid-supplied electric power.

2. Background

According to the “U.S. Department of Energy National Transmission Grid Study”, May 2002, over the next decade, electricity demand in the United States is projected to grow 20%, while the carrying capacity of the nation's high voltage transmission system is projected to increase by only 6%. This will result in bottlenecks in the nation's power grid as well as increased electricity prices. As building tenants expand their use of and reliance upon sophisticated power-hungry equipment and networks, they will increasingly seek buildings that address their need for adequate capacity and systems back-up.

One potential way of dealing with this issue is to provide alternative power sources, such as distributed generation systems, for supplying power to a building. However, in the past, the market has not accepted such alternative power sources because (1) the utility interface was incompatible; (2) the power utility pricing structure was so inflexible it would not provide an economic advantage to a building owner who used new, more efficient, distributed generation systems; and (3) local building codes did not include distributed generation requirements, leaving inspectors unable to approve systems. Others have attempted to solve this problem by providing distributed generation “peak power” capabilities that are only used secondarily to the grid power. However, this approach has not worked because inflexible utility pricing structures do not allow building owners to realize the full economic benefit of distributed generation peak power systems.

What is needed, then, is a method for supplying power to a building using alternative power generation sources, such as distributed generation systems, that addresses one or more of the foregoing shortcomings of the prior art. For example, the desired method should permit energy to be supplied to a building using distributed generation equipment in a manner that is compatible with the utility interface and that offers an economic advantage to both the energy provider and the building owner. Additionally, the desired method should allow the alternative power generation sources to supply backup power to the building when utility-supplied power is unavailable.

### BRIEF SUMMARY OF THE INVENTION

The present invention is directed to a method for providing energy to a building using distributed generation equipment in a manner that is compatible with the utility interface and that offers an economic advantage to both the energy provider and the building owner. For example, a method in accordance with the present invention includes installing utility-compatible distributed generation equipment in a building, installing a gas delivery system in the building capable of delivering natural gas from a gas utility interface to the distributed generation equipment in a manner that meets the gas pressure and volume requirements of the distributed generation equipment, requiring that energy provided by the distributed generation equipment be used on a first use basis, and charging the same amount for the energy provided by the distributed generation equipment as would have been charged by a utility or a third-party supplier and a utility.

With respect to the foregoing method, the energy provided by the distributed generation equipment may include electric power or a combination of electric power and thermal energy (as used herein, “thermal energy” encompasses heating and/or cooling) and the distributed generation equipment may include one or more of a microturbine, a reciprocating engine, a fuel cell, or other types of generation units. The foregoing method may further include one or more of the following steps: configuring the distributed generation equipment to work both in parallel with a utility energy source and to work independently with respect to the utility energy source; configuring the distributed generation equipment to supply backup power to the building when utility-supplied power is unavailable; and/or sizing the distributed generation equipment to meet approximately all of the thermal energy requirements of the building but less than the total electric power requirements of the building.

In another aspect of the present invention, the foregoing method may further include paying rent for areas in the building in which the distributed generation equipment is installed. The rent may include a fixed rent amount and an incentive rent amount. The fixed rent amount may be adjusted on a periodic basis based on an average energy cost for the building.

An alternative method in accordance with an embodiment of the present invention includes authorizing an energy provider to install or have installed in the building utility-compatible distributed generation equipment and a gas delivery system capable of delivering natural gas from a gas utility interface to the distributed generation equipment in a manner that meets the gas pressure and volume requirements of the distributed generation equipment, using energy provided by the distributed generation equipment on a first use basis, and paying the energy provider approximately the same amount for the energy provided by the distributed generation equipment as would have been paid to a utility or a utility and third-party supplier.

With respect to the foregoing method, the energy provided by the distributed generation equipment may include electric power or a combination of electric power and thermal energy and the distributed generation equipment may include one or more of a microturbine, a reciprocating engine system, a fuel cell, or other types of generation units. The foregoing method may further include one or more of the following steps: using the distributed generation equipment both in parallel with a utility energy source and independently with respect to the utility energy source; using the distributed generation equipment to supply backup power to the building when utility-supplied power is unavailable; and/or using the distributed generation equipment to meet approximately all of the thermal energy requirements of the building but less than the total electric power requirements of the building.

In another aspect of the present invention, the foregoing method may further include receiving rent from the energy provider for areas in the building in which the distributed generation equipment is installed. The rent may include a fixed rent amount and an incentive rent amount. The fixed rent amount may be adjusted on a periodic basis based on increases or decreases in the average energy cost for the building.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a flowchart of a method for providing energy to a building using utility-compatible distributed generation equipment in accordance with an embodiment of the present invention.

FIG. 2 is flowchart of a method for calculating a rent amount payable from an energy provider to a building owner in accordance with an embodiment of the present invention.

FIG. 3 is a flowchart of a method for determining a new fixed rent amount on a periodic basis in accordance with an embodiment of the present invention.

FIG. 4 is a flowchart of a method for calculating a payment amount associated with the provision of electric energy to a building by distributed generation equipment in accordance with an embodiment of the present invention.

FIG. 5 is a flowchart of a method for calculating a payment amount associated with the provision of thermal energy to a building by distributed generation equipment in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE INVENTION

### I. Method for Providing Energy to a Building Using Utility-Compatible Distributed Generation Equipment

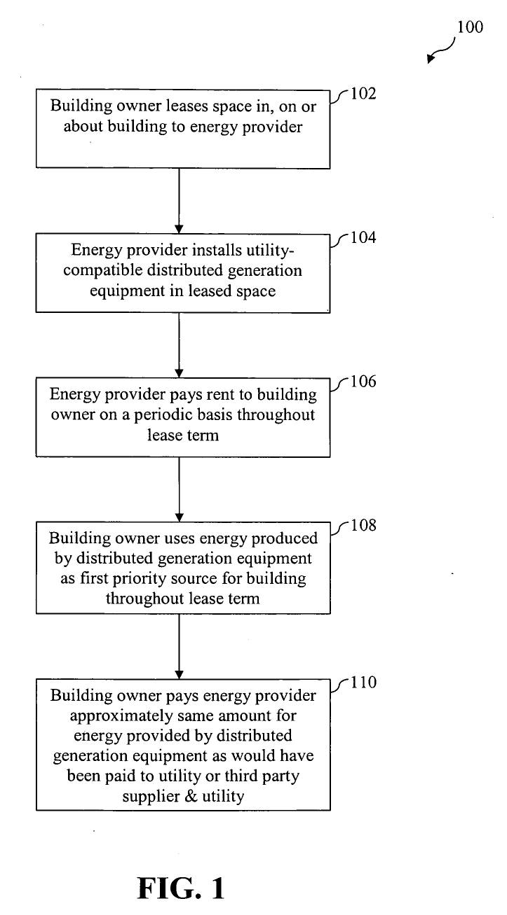

FIG. 1 is a flowchart 100 of a method for providing energy to a building using utility-compatible distributed generation equipment in accordance with an embodiment of the present invention. As will be appreciated by persons skilled in the art, the method steps of flowchart 100 are reciprocal actions to be taken by a building owner or an energy provider pursuant to an agreement between the two parties, and thus are preferably embodied in a binding written agreement executed by both parties prior to execution of any of the steps of flowchart 100. In an embodiment of the present invention, the agreement is a long-term lease and services agreement.

As used herein, the term “building” refers to any structure or structures built for human occupation or habitation, and the term “building owner” refers to a person or persons, or business entity or entities, that owns the building or otherwise has the legal right to perform the various steps attributed to the building owner as described in further detail herein. As used herein, the term “energy” includes electrical power used for operating electrical devices and equipment in or around the building and also optionally includes thermal energy used in heating and cooling the building. The term “energy provider” refers to a person or persons, or business entity or entities, that installs and operates on-site utility-compatible distributed generation equipment in the building and performs various other steps as will be described in more detail herein.

As shown in FIG. 1, the method of flowchart 100 begins at step 102 in which the building owner leases space to the energy provider. The space comprises one or more contiguous or non-contiguous areas of, in, on or about the building, or other area or areas on property adjacent to the building. The space may include for example, space in the basement of the building, on the roof of the building, or on a roof setback of the building, although these examples are not intended to be limiting. In one embodiment, the lease is for a fixed term such as ten, fifteen or twenty years. The lease term may also be made renewable at the end of any such fixed term by the building owner and/or the energy provider for the same or some other fixed term.

At step 104, the energy provider installs or has installed utility-compatible distributed generation equipment in the leased space. This installation is preferably at no capital cost to the building owner. The lease preferably also provides the energy provider with the right to operate, maintain, replace and repair the distributed generation equipment as necessary after installation. The lease may also grant non-exclusive access rights to other portions of the building so that the energy provider can provide necessary connections for the distributed generation equipment or to otherwise permit the energy provider access to the leased space.

The distributed generation equipment is designed so that it can be operated in parallel with the power grid when the grid is operating and so that it can be operated independently of the grid when the grid is not operating. The distributed generation equipment may provide combined heat and power (CHP) or combined cooling, heating and power (CCHP) for the building. In an embodiment in which the distributed generation equipment provides both electric power and thermal energy, the distributed generation equipment may be sized to meet roughly all of the thermal requirements of the building but not all of the power requirements. For example, in an embodiment, the power capability of the distributed generation equipment is in the 1 megawatt range, while the building requires 2 or more megawatts. Further description regarding the distributed generation equipment is provided in Section II, below. The provision of cooling may be provided using absorption chillers as also will be described in Section II below.

In an embodiment, the energy provider bears all costs associated with installing, operating, maintaining, repairing or replacing the distributed generation equipment. Additionally, the energy provider may be made solely responsible for obtaining all requisite approvals from governmental authorities for the purchase, installation, operation, use, repair, maintenance, testing and removal of the distributed generation equipment. The energy provider may be further responsible for all work and costs associated with securing an interconnection agreement with a local utility and the related and ongoing process of receiving licenses, permits and consents required to allow the commissioning by the local utility of the distributed generation equipment so as to allow the distributed generation equipment to operate in parallel with the power grid. Additionally, certain limitations may be placed on the installation process, such as requiring approval of installation plans by the building owner and setting an overall time limit on the process.

At step 104, the energy provider also installs or has installed a gas delivery system capable of delivering natural gas from a gas utility interface to the distributed generation equipment in a manner that meets the gas pressure and volume requirements of the distributed generation equipment. The natural gas is used to operate the distributed generation equipment. More detail about the gas delivery system will be provided in Section III, below.

At step 106, the energy provider pays rent to the building owner on a periodic basis through the term of the lease. For example, the rent may be paid monthly or annually throughout the lease term. The rent may be set to a fixed amount that does not change throughout the lease term or may be adjusted on a periodic basis throughout the lease term to account for a variety of factors, including, but not limited to, increases in the cost of electric power or the receipt of incentive payments from a governmental authority by the energy provider. As will be appreciated by persons skilled in the art, the inclusion of a rent payment provision in the agreement between the building owner and the energy provider provides an incentive to the building owner to enter into the agreement while providing the energy provider with the legal status of a tenant, and all concomitant rights accruing to that status. Further description regarding a particular method for calculating the rent amount during the lease period is set forth in Section IV, below.

At step 108, the building owner uses energy provided by the distributed generation equipment on a “first use” basis—in other words, the building owner uses the energy provided by the distributed generation equipment as the first priority energy source for the building and its tenants throughout the lease term. The building owner must use the total energy supplied by the distributed generation equipment prior to using the energy provided by a local utility or by a local utility and a third party supplier. This energy may include electric power only or may include both electric power and thermal energy in instances where the distributed generation equipment is CHP or CCHP equipment.

As noted above, the distributed generation equipment may be sized to meet all the thermal energy requirements of the building but not all the power requirements. Since the building owner is required to use both the electric power and thermal energy provided by the distributed generation equipment on a “first use” basis, this ensures maximum energy generation efficiency.

At step 110, the building owner pays the energy provider approximately the same amount for the energy provided by the distributed generation equipment as would have been paid to a local utility or to a third party supplier and a local utility for the supply and delivery of the same amount of energy. The effect of this is that the building owner pays the energy provider approximately the same amount he or she would have paid for the energy if it were obtained in the manner that normally would been used by the building owner if the energy provider were excluded from the transaction.

The foregoing payment scheme may apply to the provision of electric power by the distributed generation equipment only or to the provision of both electric power and thermal energy by the distributed generation equipment. In the case of electric power, the building owner pays the same price per kilowatt (kW) and kilowatt hour (kWh) that would otherwise be paid for utility-delivered power. In an embodiment of the present invention that uses a highly efficient CHP system, the cost to the energy provider of generating the power will be substantially lower than the cost of the displaced grid power, resulting in a profit margin to the energy provider. More details concerning particular methods for calculating the amount to be paid by the building owner to the energy provider for electric power and thermal energy will be provided in Section V, below.

The foregoing method of flowchart 100 can serve to provide grid-independent, high quality, computer-grade power to building owners and tenants (where appropriate) that serves as protection against grid-related disruptions and/or outages that can damage sensitive equipment or result in system failures.

The first use requirement described above with reference to step 108 in addition to the pricing based upon displaced utility energy as described above with reference to step 110 represents an economic breakthrough for distributed generation, CHP, and alternative energy. With the foregoing economic model, the building owner pays the same price for energy that he or she would normally have paid for energy provided by a utility, but now receives the benefits of back-up power and thermal energy that can be sold as a benefit to tenants. Since the more efficient energy source results in much lower cost of energy, this economic advantage is realized in the energy provider's profit margin without any involvement of utilities, rate commissions, or other government institutions. This profit margin justifies the capital investment by the energy provider and, thereby, the expansion of distributed generation.

As noted above, in an embodiment of the present invention, the reciprocal actions to be taken by the building owner and energy provider are performed pursuant to a lease and services agreement entered into by both parties. This agreement permits the energy provider to secure the long-term legal rights to provide first use electric and thermal energy to the building. The consideration for this legal right is provided, in part, through the payment of rent by the energy provider to the building owner. This unique arrangement ensures that the energy provider obtains a desirable return on investment for the installation, operation and maintenance of the distributed generation equipment in or around the building.

Other potential advantages that may accrue from embodiments of the present invention include but are not limited to: (1) the reduction of carbon, various nitrogen oxides (NOₓ) and sulfur dioxide (SO₂) emissions as compared to displaced grid power through higher system efficiency and the use of natural gas; (2) the provision of a unique service that makes easy-to-install outage protection available to a building and/or its tenants; (3) power back-up capability that a building owner can offer to attract or retain high value tenants; (4) a building owner's ability to market a property as environmentally friendly and in many instances as a “green power” building; (5) a building owner's ability to charge tenants for the backup power capability; and (6) other beneficial services that may be provided by the energy provider to the building owner in accordance with an embodiment of the present invention including energy audits and demand-side recommendations as well as responsive and user-friendly pricing programs, customer service and operating procedures.

### II. Utility-Compatible Distributed Generation Equipment in Accordance with an Embodiment of the Present Invention

As discussed above with reference to step 104 of flowchart 100, the energy provider installs utility-compatible distributed generation equipment in a space in, on, or around the building that is leased from the building owner. In an embodiment of the invention, the distributed generation equipment is both utility-compatible, in that it has an interface that is compatible with the utility interface (e.g., the interface to the grid) and can be used for power or cogeneration, as well as utility-independent in that it can be operated even when the utility is incapable of providing power. Thus, the distributed generation equipment can serve as protection against grid-related disruptions and/or outages that can damage sensitive equipment or result in system failures.

A wide variety of alternative technologies may be used to provide both grid-parallel and grid-independent, self-generated electric power to a building in accordance with the present invention. As noted above, the distributed generation equipment may be used to provide grid-parallel power to reduce a building's peak demand usage and overall consumption of purchased power while also providing enough grid-independent distribution to meet critical tenant demands during system outages and brownouts. In a preferred embodiment, the electric power produced by the distributed generation equipment will comprise from 20% to 30% of a building's peak load electricity requirements. Expressed in terms of kilowatts (kWs), a typical 250,000 square foot multi-tenant office building with a 60% load factor and average and peak demands of 650 kW and 1,100 kW, respectively, would require from 220 kW to 325 kW of self-generated electricity. The overall plan selected for each building may depend on a myriad of factors including cost, flexibility, physical and environmental constraints, tenancy and expected growth in demand.

In some embodiments of the present invention, the exhaust from the distributed generation equipment is used to provide heating (direct or indirect) and cooling to supplement a building's existing thermal systems. The utilization of this thermal energy can reduce a building's fuel consumption and overall usage of electricity while also, in many instances, increasing the efficiency of the distributed generation equipment to in excess of 70%.

A. Example Distributed Generation Equipment

The distributed generation equipment may include, but is not limited to, microturbines, reciprocating engines, and fuel cells. Each of these various technologies will now be briefly described.

Microturbines. The current generation of commercially distributed microturbines offers reliable, environmentally friendly, high quality power on a cost-effective basis. They use a wide variety of fuels and are typically low maintenance. Microturbines provide both grid-parallel and grid-independent power. With cogeneration, using both heat and power, units can reach system efficiencies of more than 70% and in some instances up to 90%.

Currently, there are several microturbine manufacturers that offer commercially viable units that may be used to provide on-site utility-compatible power generation in accordance with an embodiment of the present invention. For example, Capstone Turbine Corporation (“Capstone”) of Chatsworth, Calif. offers a basic microturbine unit that is the size of a refrigerator and delivers 60 kW of power which, through its “MultiPac” system, can be expanded to several megawatts. Based on the same principles as a jet engine, these units are capable of producing reliable, low emission systems that are virtually maintenance-free. Capstone's microturbines are smaller, lighter and operate with less noise and vibration than reciprocating engine systems. Importantly, these units produce very low levels of fault current which make them much more acceptable than reciprocating engines for interconnection to utility network systems.

Elliott Energy Systems, Inc. (“Elliott”) of Stuart, Fla. offers a microturbine that provides 100 kW of electrical power and 172 kW of thermal exhaust power. Depending upon end user application, these units can provide total overall thermal efficiencies exceeding 85%. Similar to Capstone's microturbines, Elliott's units have a built-in heat exchanger and produce very low levels of fault current.

Reciprocating Engine Systems. Reciprocating (piston-driven internal combustion) engine generators presently provide the bulk of distributed generation equipment available in multi-tenant office properties. In virtually all instances, these systems are installed by owners to provide required fire and life safety power or by a major tenant (typically occupying more than 25% of a property) to provide short-term outage protection for sensitive computer and telecommunications equipment. In general, these systems are less expensive than newer generation equipment, fairly reliable, have good load-following characteristics, and have co-generation potential. Newer, better designed, gas fired models offer efficiencies in the 35% to 40% range while significantly reducing pollutant emissions and noise levels that have plagued earlier units. While there are numerous producers of these generators, proven products with capacities ranging from 100 kW to several megawatts (MWs) are offered by Caterpillar® of Peoria, Ill., Cummins Inc. of Columbus, Ind., Detroit Diesel Corporation of Detroit, Mich., the Waukesha Engine Division of Dresser Industries, located in Waukesha, Wis., General Electric Energy of Atlanta, Ga., and Daewoo International Corp. of Seoul, Korea.

In accordance with the present invention, reciprocating engine generators can be effectively employed in a wide range of properties with particular emphasis on buildings where environmental issues are less critical and cost is somewhat more important. Furthermore, reciprocating engine generators may be used in radial distribution system installations.

Fuel Cells. Fuel cells provide clean, reliable, grid-parallel and grid-independent power as well as thermal energy that can be used to supplement a property's heating and/or cooling systems. Similar to a battery, fuel cells use an electrochemical process to directly convert chemical energy into electricity and hot water. This chemical energy typically comes from hydrogen that is extracted from natural gas or virtually any other hydrocarbon fuel. However, since the fuel cell does not burn the gas, it operates virtually pollution-free and with very little noise. With heat recapture, fuel cells can achieve efficiencies approximating 80%.

To date, fuel cells have not been used extensively in commercial buildings. The primary reason for this has been the high front-end cost to purchase and install each unit. This has limited fuel cell use, for the most part, to specialized situations where other factors such as reliability and environmental concerns outweigh the unit's higher initial cost.

The largest producer of stationary fuel cells in commercial use today is International Fuel Cells (“IFC”), a division of United Technologies Inc. IFC's units are currently operating in more than 200 locations around the world. These are phosphoric acid fuel cells that generate 200 kW and 900,000 Btu/hr. They have a fuel efficiency of 40% that can increase to nearly 85% if the steam produced by the unit is used for cogeneration. IFC and many other companies are currently in the process of developing next generation products that will have both higher efficiencies and lower costs. Many of these new systems are currently operating in demonstration programs that if successful could be available commercially within the next year or two.

The current generation of fuel cells may advantageously be used in urban properties where allowable pollution and noise levels tend to be lower than those accepted at suburban locations. Since many urban buildings have higher rental rates, tenants in these properties will tend to be less sensitive to operating cost increases when such expenses represent only a minor percentage of their overall occupancy cost.

B. Example Cooling Equipment

As noted above, in some embodiments of the present invention, the exhaust from the distributed generation equipment is used to provide heating and cooling to supplement a building's existing thermal systems. Where cooling is provided, single-effect absorption chillers may be used.

A single-effect absorption chiller uses a low temperature energy source (such as hot water or low pressure steam) to produce chilled water for use in air conditioning. These machines are ideally fitted for use with distributed generation equipment installed in office buildings. Thermal energy recovered from the distributed generation equipment is converted to chilled water for use in cooling the office building during summer months. The same heat recovery equipment installed to heat the building during the winter months can also be used to produce cooling during summer months, resulting in year-round utilization of the heat recovery equipment. The machines offer simple, quiet, reliable operation and have very low parasitic electrical requirements.

Currently there are several manufacturers that produce single-effect absorption chillers, including Carrier Corporation, York International Corporation, The Trane Company, Yazaki Energy Systems, Broad Air Conditioning Ltd., Sanyo, Thermax Inc. and Kuyungwon-Century Co. Since all the manufacturers use the same absorption refrigeration cycle, the performance of their machines is nearly identical.

### III. Delivery of Natural Gas to Distributed Generation Equipment in Accordance with an Embodiment of the Present Invention

As discussed above with reference to step 104 of flowchart 100, the energy provider installs or has installed a gas delivery system capable of delivering natural gas from a gas utility interface to the distributed generation equipment in a manner that meets the gas pressure and volume requirements of the distributed generation equipment. Fuel delivery is a major component of the method described herein for providing energy to a building using utility-compatible distributed generation equipment. In accordance with the present invention, the fuel delivery system must be capable of delivering the fuel at the required volume and pressure to operate the distributed generation plant. Natural gas is the preferred fuel for operating the distributed generation equipment.

In accordance with an embodiment of the present invention, a Gas Blower Module (GBM) is used to perform natural gas fuel delivery. The GBM operates to increase the gas pressure delivered by the gas utility to the distributed generation equipment located within the building. The GBM is designed to operate at varying speed to match the gas delivery to the fuel requirements of the distributed generation plant.

It is not necessarily the case that a gas utility can deliver adequate gas pressure and volume to a building to meet the requirements of the distributed generation equipment. Also, local building codes and authorities having jurisdiction regulate the level of gas pressure that can be installed within large multi-tenant office buildings. The GBM is designed to respond to these challenges. The GBM provides an innovative, flexible and cost-effective solution in delivering the required gas pressure and volume to installed distributed generation equipment, regardless of the location within the building.

Gas safety is extremely important. A GBM in accordance with an embodiment of the present invention is designed to also incorporate manual and automatic gas safety devices, including safety shutoff valves, flame arrestor, pressure and temperature safeties and emergency power off (EPO) buttons. The GBM is fabricated as a complete assembly with all electrical and mechanical devices mounted on a single base frame for quick and easy installation. Supervisory Control and Data Acquisition (SCADA) controls may be incorporated within the GBM to provide automatic operation and remote monitoring and control.

In accordance with a preferred embodiment of the present invention, the GBM consists of two major components: hardware and controls.

With respect to hardware, the preferred GBM assembly is constructed of two Eclipse-brand single-stage 7½ horsepower fan assemblies. Although one gas blower may be sufficient to supply a distributed generation plant, two are preferably included in the assembly to provide backup. The two blowers are mounted on a preassembled skid which includes all the required piping, shut off valves, vibration elimination components, check valves, and all other requisite fittings and pipe. The assembly also includes an automatic bypass flow valve which allows gas to bypass the blower while it is operating in order to maintain flow and pressure during light-load operations.

With respect to controls, the GBM assembly is powered and controlled by a wall-mounted power and control cabinet, also prefabricated to match the GBM assembly. The cabinet may be modified to take into account light load operating conditions and provide additional safety measures for the system. Custom augmentations to the system preferably include: the addition of two commercially-available 7½ horsepower Variable Frequency Drives (VFD) to help the assembly run at desired speeds, help reduce the power draw during startup, and reduce the parasitic load drawn by the assembly during normal operation; additional pressure sensors to help maintain desired pressure inside the pipe; additional controls designed so that if one blower fan trips the second will start automatically, thus maintaining flow and pressure; and the addition of Automated Logic components which allow integration with the rest of the installation and provide constant monitoring and control from remote locations.

### IV. Rent Calculation in Accordance with an Embodiment of the Present Invention

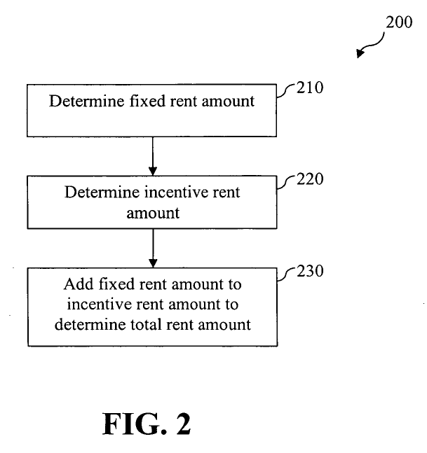

As noted above in reference to step 106 of flowchart 100, the energy provider pays rent to the building owner on a periodic basis throughout the lease term, wherein the rent may be set to a fixed amount that does not change throughout the lease term or may be adjusted on a periodic basis throughout the lease term to account for a variety of factors. As shown in flowchart 200 of FIG. 2, in accordance with an embodiment of the present invention, the rent is calculated by first determining a fixed rent amount as shown at step 210, determining an incentive rent amount as shown at step 220, and then adding the fixed rent amount to the incentive rent amount to arrive at a total rent amount as shown at step 230. The manner in which the fixed and incentive rent amounts are determined will now be described.

Fixed rent amount. In an embodiment of the present invention, the fixed rent amount is an annual amount that is paid by the energy provider to the building owner in periodic installments (e.g., monthly or quarterly). For example, the fixed rent amount may be paid in monthly installments and prorated for a partial month at the beginning or end of the lease term. The fixed rent may be due, for example, on the first of each calendar month. An initial fixed rent amount is determined at the time the building owner and the energy provider first enter into the lease agreement. However, the fixed rent is adjusted annually throughout the lease term. For example, the fixed rent may be adjusted on the 30th day after the first anniversary of the commencement date of the lease and on the 30th day after each subsequent anniversary of the commencement date of the lease during the lease term. Upon calculation, the revision to the fixed rent amount may be applied retroactively so as to establish the fixed rent for the year beginning on the anniversary of the commencement date of the lease.

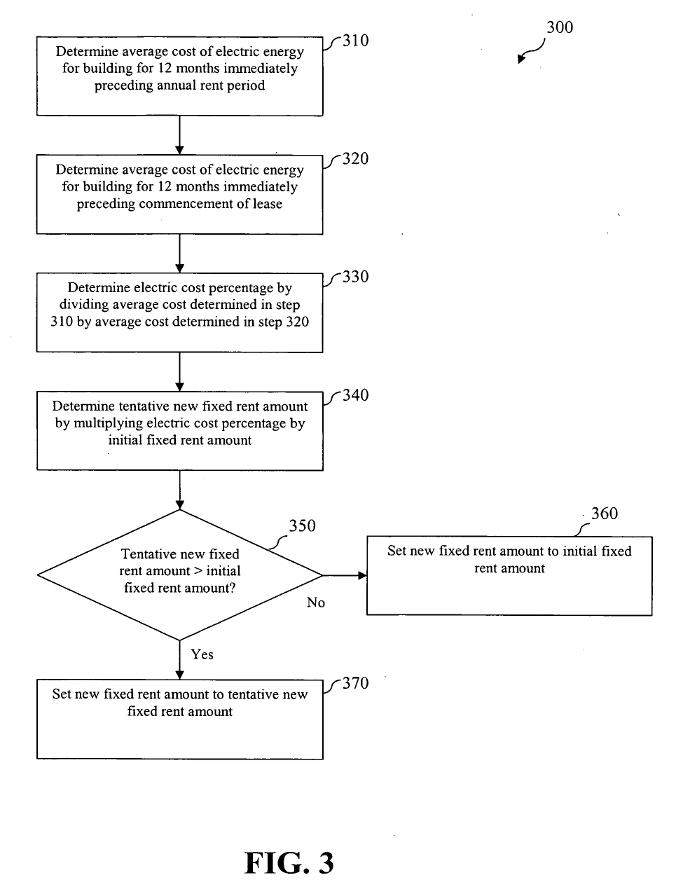

FIG. 3 is a flowchart 300 of a method for annually calculating the new fixed rent amount in accordance with an embodiment of the present invention. As shown in FIG. 3, the method begins at step 310 in which the average cost per Kilowatt-hour (kWh) of electric energy for the building for the 12 months immediately preceding the current annual rent period is determined. This cost may be calculated by first determining a recorded total electric usage amount in kWh for the building for the relevant 12 month period. A total service charge is then calculated, wherein the total service charge is the amount the building owner would have paid to a local utility, or local utility and a third party supplier, for the supply and delivery of the recorded total electric usage amount. The average cost is then determined by dividing the total service charge by the recorded total electric usage amount.

At step 320, the average cost per kWh of electric energy for the building for the 12 months immediately preceding the commencement of the lease is determined. This average cost may be based on the actual cost paid by the building owner during the relevant 12 month period for the supply of electric energy from a local utility or a third party supplier and for the delivery of such electric energy by the local utility.

At step 330, the average cost determined in step 310 is divided by the average cost determined in step 320 to arrive at an electric cost percentage. At step 340, a tentative new fixed rent amount is calculated by multiplying the electric cost percentage by the initial fixed rent amount. At step 350, the tentative new fixed rent amount is compared to the initial fixed rent amount. If the tentative new fixed rent amount is not greater than the initial fixed rent amount then the new fixed rent amount is set to the initial fixed rent amount as indicated at step 360. If the tentative new fixed rent amount is greater than the initial fixed rent amount, then the tentative new fixed rent amount is selected as the new fixed rent amount as indicated at step 370.

The foregoing method for annually calculating a new fixed rent amount has the effect of increasing the fixed rent amount payable to the building owner where the average cost of electric energy for the building the previous year exceeded the average cost of electric energy for the building in the year prior to entering into the lease agreement. This provides the building owner with a benefit in terms of increased rent that will offset, at least to a limited extent, price increases for electric energy. However, the method ensures that the new fixed rent amount will never drop below the initial fixed rent amount.

Incentive Rent. In accordance with an embodiment of the present invention, the energy provider may obtain (or may agree to make reasonable efforts to obtain) during the term of the lease incentive payments from governmental authorities for which the power equipment, and the acquisition, installation and operation thereof may be qualified. The building owner may agree to cooperate with any efforts to obtain these incentive payments. If the energy provider receives money from a governmental authority in connection with the purchase and/or installation of power equipment in the building, the net amount after deducting application or other fees and out-of-pocket costs for collecting the money is called the incentive payment. In accordance with an embodiment of the invention, the energy provider may give an agreed upon portion of the incentive payment as incentive rent to the building owner. Such payments may be made in equal annual installments over the remaining term of lease agreement starting on the first day of the calendar year immediately following the year in which the incentive payment was received.

### V. Calculation of Payment Amount for Energy Provided by Distributed Generation Equipment in Accordance with an Embodiment of the Present Invention

As noted above in reference to step 110 of flowchart 100, the building owner pays the energy provider approximately the same amount for energy provided by the distributed generation equipment as would have been paid to a local utility or to a third party supplier and a local utility for the supply and delivery of the same amount of energy. In an embodiment of the present invention, the energy provider submits an invoice for the amount due to the building owner for energy provided during each service period, wherein the service period is the same as a billing period set by a local utility. A first invoice may be provided for electric power and a second invoice may be provided for thermal energy. The building owner is then required to pay the amounts due under the invoices within a predetermined time period.

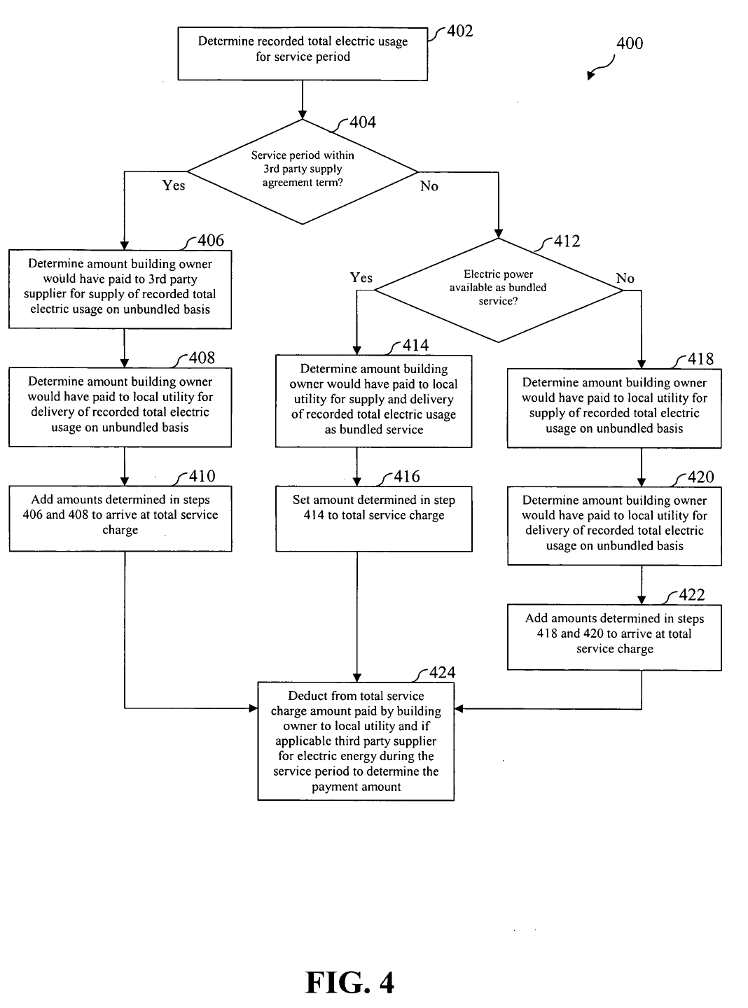

FIG. 4 is a flowchart 400 of an example method for calculating a payment amount associated with the provision of electric energy to the building by the distributed generation equipment. To facilitate the calculations performed in flowchart 400, the building owner may be required to provide the service provider with copies of bills from a local utility and any third-party supplier that supplies electric energy for the building within a predetermined time (e.g., 20 days) following receipt of such bills.

The method of flowchart 400 begins at step 402, in which a recorded total electric usage is determined for the service period. The recorded total electric usage is the total usage of electric energy for the building as measured in Kilowatt hours (kWh) and Kilowatts (kW) and as recorded for the service period by meters or the like. The recorded total electric usage includes the electric energy supplied by a local utility or third party supplier and delivered by the local utility plus the electric energy provided by the distributed generation equipment.

At step 404, it is determined whether the service period is within the term of a third party supply agreement which may exist between the building owner and a third party supplier for the supply of electric power to the building. If the service period is within the term of such a third party supply agreement, then the method proceeds to step 406, in which the amount the building owner would have paid to the third party supplier for the supply of the recorded total electric usage on an unbundled basis is determined. Following step 406, the amount the building owner would have paid to a local utility for delivery of the recorded total electric usage on an unbundled basis is determined, as indicated at step 408. At step 410, the amounts determined in steps 406 and 408 are added together to arrive at a total service charge.

If however, at step 404, it is determined that the service period is not within the term of a third party supply agreement, then the method proceeds to step 412, in which it is determined whether electric power is available to the building as a bundled or unbundled service. If electric power is available as a bundled service, then the method proceeds to step 414, in which an amount the building owner would have paid to a local utility for the supply and delivery of the recorded total electric usage as a bundled service is determined. The amount determined in step 414 is then set to the total service charge as shown at step 416.

If however, at step 412, it is determined that electric power is not available as a bundled service, then the method proceeds to step 418, in which the amount the building owner would have paid to a local utility for the supply of the recorded total electric usage on an unbundled basis is determined. Following step 418, the amount the building owner would have paid to a local utility for the delivery of the recorded total electric usage on an unbundled basis is determined, as shown at step 420. At step 422, the amounts determined in steps 418 and 420 are added together to arrive at the total service charge.

Regardless of whether the total service charge is calculated in step 410, 416 or 422, after each of these steps, the method proceeds to step 424. In step 424, the amount paid by the building owner for electric energy during the service period to any third party supplier and to a local utility for either bundled service or, on an unbundled basis, third party or utility supply service and utility delivery service, is deducted from the total service charge to determine the payment amount due to the energy provider for the service period.

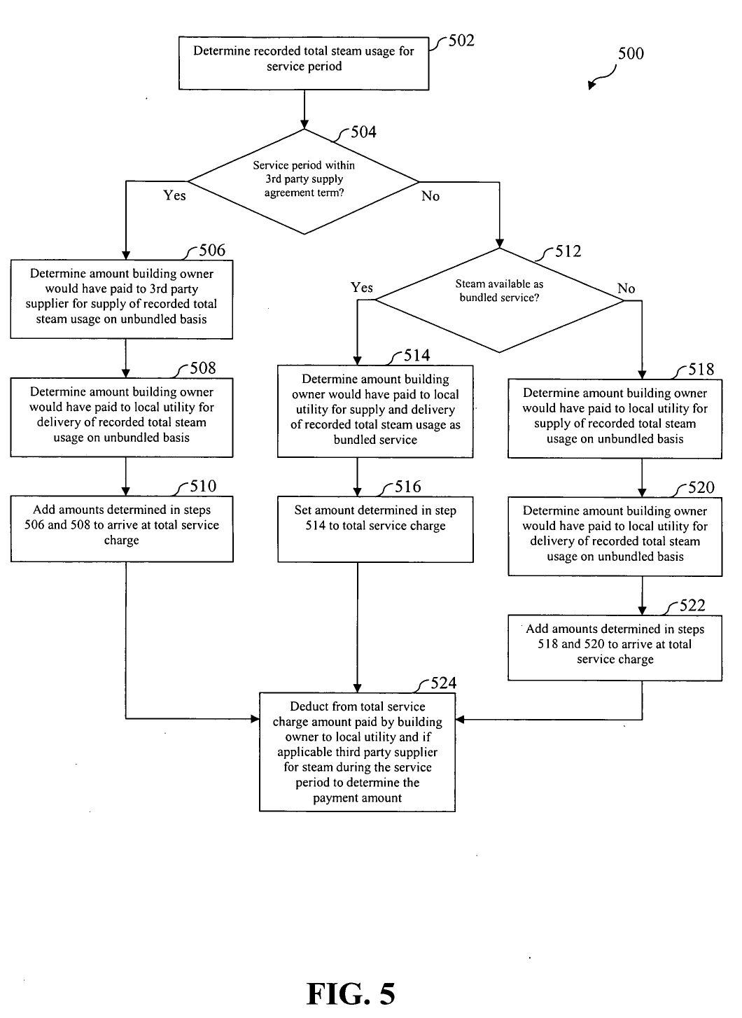

FIG. 5 is a flowchart 500 of an example method for calculating a payment amount associated with the provision of thermal energy to the building by the distributed generation equipment. To facilitate the calculations performed in flowchart 500, the building owner may be required to provide the service provider with copies of bills from a local utility and any third-party supplier that supplies thermal energy for the building within a predetermined time (e.g., 20 days) following receipt of such bills.

The flowchart 500 relates to a scenario in which a district steam loop is being used and usage is measured in pounds of steam or pounds of steam per hour. However, the general concept of flowchart 500 can be readily applied to other systems that provide thermal energy to a building, such as oil-based or coal-based systems. The necessary modifications to flowchart 500 of FIG. 5 to accommodate such systems (including the necessary usage measurements) will be readily understood by persons skilled in the art. The present invention is by no means limited to the use of a district steam loop.

The method of flowchart 500 begins at step 502, in which a recorded total steam usage is determined for the service period. The recorded total steam usage is the total usage of steam for the building as measured in pounds of steam or pounds of steam per hour and as recorded for the service period by meters or the like. The recorded total steam usage includes the steam supplied by a local utility or third party supplier and delivered by the local utility plus the steam equivalent provided by the distributed generation equipment.

At step 504, it is determined whether the service period is within the term of a third party supply agreement which may exist between the building owner and a third party supplier for the supply of steam to the building. If the service period is within the term of such a third party supply agreement, then the method proceeds to step 506, in which the amount the building owner would have paid to third party supplier for the supply of the recorded total steam usage on an unbundled basis is determined. Following step 506, the amount the building owner would have paid to a local utility for delivery of the recorded total steam usage on an unbundled basis is determined, as indicated at step 508. At step 510, the amounts determined in steps 506 and 508 are added together to arrive at a total service charge.

If however, at step 504, it is determined that the service period is not within the term of a third party supply agreement, then the method proceeds to step 512, in which it is determined whether steam is available to the building as a bundled or unbundled service. If steam is available as a bundled service, then the method proceeds to step 514, in which an amount the building owner would have paid to a local utility for the supply and delivery of the recorded total steam usage as a bundled service is determined. The amount determined in step 514 is then set to the total service charge as shown at step 516.

If however, at step 512, it is determined that steam is not available as a bundled service, then the method proceeds to step 518, in which the amount the building owner would have paid to a local utility for the supply of the recorded total steam usage on an unbundled basis is determined. Following step 518, the amount the building owner would have paid to a local utility for the delivery of the recorded total steam usage on an unbundled basis is determined, as shown at step 520. At step 522, the amounts determined in steps 518 and 520 are added together to arrive at the total service charge.

Regardless of whether the total service charge is calculated in step 510, 516 or 522, after each of these steps, the method proceeds to step 524. In step 524, the amount paid by the building owner for steam during the service period to any third party supplier and to a local utility for either bundled service or, on an unbundled basis, third party or utility supply service and utility delivery service, is deducted from the total service charge to determine the payment amount due to the energy provider for the service period.

The foregoing methods of flowcharts 400 and 500 have been provided by way of example only. Various other methods may be used to determine amounts payable to the energy provider for electric power and thermal energy produced by the distributed generation equipment in accordance with the present invention. Note that taxes, fees and other charges imposed on the building owner by a local utility or third party supplier may be borne either by the building owner or the energy provider depending upon the agreement between the parties. For example, in an embodiment, any standby rates imposed by a local utility on the building owner due to the use of energy produced by distributed generation are paid by the energy provider.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for providing energy to a building comprising:
installing utility-compatible distributed generation equipment in the building;
installing a gas delivery system in the building capable of delivering natural gas from a gas utility interface to the distributed generation equipment in a manner that meets the gas pressure and volume requirements of the distributed generation equipment;
requiring that energy provided by the distributed generation equipment be used on a first use basis; and
charging the same amount for the energy provided by the distributed generation equipment as would have been charged by a utility or a third-party supplier and a utility.

2. The method of claim 1, wherein the energy provided by the distributed generation equipment includes electric power.

3. The method of claim 2, wherein the energy provided by the distributed generation equipment further includes thermal energy.

4. The method of claim 1, further comprising:
sizing the distributed generation equipment to meet approximately all of the thermal energy requirements of the building but less than the total electric power requirements of the building.

5. The method of claim 1, further comprising:
paying rent for areas in the building in which the distributed generation equipment is installed.

6. The method of claim 5, wherein the rent comprises a fixed rent amount and an incentive rent amount.

7. The method of claim 6, further comprising:
adjusting the fixed rent amount on a periodic basis based on an average energy cost for the building.

8. The method of claim 1, wherein the distributed generation equipment includes at least one of: a microturbine, a reciprocating engine, and a fuel cell.

9. The method of claim 1, further comprising:
configuring the distributed generation equipment to work both in parallel with a utility energy source and to work independently with respect to the utility energy source.

10. The method of claim 1, further comprising:
configuring the distributed generation to supply backup power to the building when utility-supplied power is unavailable.

11. A method for providing energy to a building comprising:
authorizing an energy provider to install or have installed in the building utility-compatible distributed generation equipment and a gas delivery system capable of delivering natural gas from a gas utility interface to the distributed generation equipment in a manner that meets the gas pressure and volume requirements of the distributed generation equipment;
using energy provided by the distributed generation equipment on a first use basis; and
paying the energy provider approximately the same amount for the energy provided by the distributed generation equipment as would have been paid to a utility or a utility and third-party supplier.

12. The method of claim 11, wherein the energy provided by the distributed generation equipment includes electric power.

13. The method of claim 12, wherein the energy provided by the distributed generation equipment further includes thermal energy.

14. The method of claim 11, further comprising:
using the distributed generation equipment to meet approximately all of the thermal energy requirements of the building but less than the total electric power requirements of the building.

15. The method of claim 11, further comprising:
receiving rent for areas in the building in which the distributed generation equipment is installed.

16. The method of claim 15, wherein the rent comprises a fixed rent amount and an incentive rent amount.

17. The method of claim 16, further comprising:
adjusting the fixed rent amount on a periodic basis based on an average energy cost for the building.

18. The method of claim 11, wherein the distributed generation equipment includes at least one of: a microturbine, a reciprocating engine, and a fuel cell.

19. The method of claim 11, further comprising:
using the distributed generation equipment both in parallel with a utility energy source and independently with respect to the utility energy source.

20. The method of claim 11, further comprising:
using the distributed generation equipment to supply backup power to the building when utility-supplied power is unavailable.

21. A method for providing energy to a building comprising:
entering into a legally-binding agreement to install utility-compatible distributed generation equipment in the building; and
via the legally-binding agreement, securing the right to provide first use electric and/or thermal energy to the building using the distributed generation equipment in return for payment from the building owner;
wherein installing the utility-compatible distributed generation equipment in the building includes installing a gas delivery system in the building capable of delivering natural gas from a gas utility interface to the distributed generation equipment in a manner that meets the gas pressure and volume requirements of the distributed generation equipment.

22. The method of claim 21, wherein the legally-binding agreement includes a lease of property upon which the distributed generation equipment is to be installed.
